(19) United States
(12) Patent Application Publication
(10) Pub. No.: US 2019/0050684 A1
(43) Pub. Date: Feb. 14, 2019

(54) MACHINE LEARNING DEVICE AND METHOD

(71) Applicant: HITACHI, LTD., Tokyo (JP)

(72) Inventors: Nobukazu KONDO, Tokyo (JP); Jumpei OKOSHI, Tokyo (JP); Naofumi HAMA, Tokyo (JP)

(21) Appl. No.: 15/936,942

(22) Filed: Mar. 27, 2018

(30) Foreign Application Priority Data
Aug. 9, 2017 (JP) 2017-154837

(51) Int. Cl. G06K 9/62; G06T 7/00

(52) U.S. Cl. CPC G06K 9/6262; G06T 2207/20081; G06T 7/0004

(57) ABSTRACT

Proposed are a machine learning device and a machine learning method capable of performing machine learning in a short time and an efficient manner. For each learning target, image processing having a high learning effect regarding the learning target is set in advance. When image processing has been set regarding a learning target included in the image for each image based on teaching data set prepared in advance, a processed image of the image is generated by performing the image processing to that image. By learning a learning target with image data of the generated processed image as the teaching data, basic learning information configured from externally acquired basic learning results can be tuned.

### TECHNICAL FIELD

The present invention relates to a machine learning device and a machine learning method, and, for example, can be suitably applied to a machine learning device which performs machine learning of a learning target included in an image.

### BACKGROUND ART

In recent years, AI (Artificial Intelligence) technology is attracting attention, and, as a result, the research of machine learning is being conducted actively. In the industrial sectors also, the R&D of machine learning is being promoted actively with an eye on improving the recognition accuracy in product inspection, processing control and error monitoring, and reducing the SI (System Integration) cost upon changing the control specification.

Moreover, in recent years, the smartification of factories (realization of smart factories) is also being promoted, and the further advancement of machine learning technologies is expected. Here, the term “smart factory” refers to a factory in which all machines, including sensors and devices, are connected via the internet, and clarification of the causal relation among various types of information such as quality and status is realized, whereby the devices mutually operate in a coordinated manner, or the devices and workers operate in a coordinated manner.

Note that, in relation to machine learning, NPTL 1 and NPTL 2 below disclose a framework of image learning capable of performing highly accurate image recognition even when the number of images prepared by the client is small by incorporating, into an image recognition platform, the learning result of having learned several thousand classes, or approximately 1.5 million images, in advance.

### CITATION LIST

### Non-Patent Literature

[NPTL 1]

“[AI Introduction] More Personal, More Dramatic—Image Recognition Platform”, [online], NTT Comware, [Searched on Jul. 3, 2017], internet <URL: http://www.nttcom.co.jp/dL/>
[NPTL 2]

“We can build your company's own image recognition AI, NTT Comware—Easy to adopt even for “AI beginner” companies”, [online], Nikkei Technology Online, [Searched on Jul. 3, 2017], internet <URL: http://techon.nikkeibp.co.jp/atclinews/16/030106520/?rt=nocnt>

### SUMMARY OF THE INVENTION

### Problems to be Solved by the Invention

Meanwhile, for instance, in cases of introducing AI into a smart factory or the like, even if the technologies disclosed in NPTL 1 and NPTL 2 are applied to such AI, learning time of several months is required for the relearning process associated with changes to the product specification.

In addition, because the learning time is proportional to the number of images of teaching data which need to be prepared manually, in order to shorten the learning time, there is a problem in that more workers need to be mobilized. Meanwhile, the foregoing relearning process is ideally performed within a temporal range that does not affect the factory's operation (for instance, within 1 day).

The present invention was devised in view of the foregoing points, and an object of this invention is to propose a machine learning device and a machine learning method capable of performing machine learning in a short time and an efficient manner.

### Means to Solve the Problems

In order to achieve the foregoing object, the present invention provides a machine learning device which externally acquires basic learning information configured from basic learning results, and learns a learning target by tuning the acquired basic learning information, comprising: a necessity determination unit which determines a necessity of image processing for each image based on a teaching data set prepared in advance; an image processing unit which generates a processed image by performing the required image processing to each of the images in which the necessity determination unit determined that the image processing should be performed thereto; and a learning unit which tunes the basic learning information by executing a first round of active learning by using the teaching data set, and a second round of active learning which uses image data of each of the processed images generated by the image processing unit as teaching data, wherein, for each of the learning targets, the image processing having a high learning effect regarding the learning target is set in advance, wherein, when the image processing has been set regarding the learning target included in the image based on the teach data set, the necessity determination unit determines that the image processing should be performed to that image, and wherein the image processing unit generates the processed image of one or more of the images by performing each of the image processing, which was set regarding the learning target included in the image, to the image in which the necessity determination unit determined that the image processing should be performed thereto.

Moreover, the present invention additionally provides a machine learning method to be executed by a machine learning device which externally acquires basic learning information configured from basic learning results, and learns a learning target by tuning the acquired basic learning information, comprising: a first step of tuning the basic learning information by executing a first round of active learning by using a teaching data set prepared in advance; a second step of determining a necessary of image processing to each image based on the teaching data set; a third step of generating a processed image by performing the required image processing to each of the images which was determined that the image processing should be performed thereto; and a fourth step of executing a second round of active learning which uses image data of each of the generated processed images as teaching data, wherein, for each of the learning targets, the image processing having a high learning effect regarding the learning target is set in advance, wherein, in the second step, when the image processing has been set regarding the learning target included in the image based on the teach data set, the machine learning device determines that the image processing should be performed to that image, and wherein, in the third step, the machine learning device generates the processed image of one or more of the images by performing each of the image processing, which was set regarding the learning target included in the image, to the image which was determined that the image processing should be performed thereto.

According to the machine learning device and the machine learning method of the present invention, it is possible to create processed images having a high learning effect from a minimum number of teaching data sets, and the learning target can be learned with the image data of the created processed images as the teaching data. Accordingly, in addition to being able to shorten the learning time by using the basic learning information, because there is no need to mobilize workers or spend time for creating teaching data other than the teaching data sets, learning can be performed in a short time which is dramatically shorter in comparison to conventional technologies.

### Advantageous Effects of the Invention

According to the present invention, it is possible to realize a machine learning device and a machine learning method capable of performing machine learning in a short time and an efficient manner.

### BRIEF DESCRIPTION OF DRAWINGS

FIG. 1 is a block diagram showing the overall configuration of the machine learning system according to this embodiment.

FIG. 2 is a diagram showing the configuration of the preprocessing execution necessity management table.

FIG. 3 is a diagram showing the configuration of the preprocessing candidate item list.

FIG. 4 is a block diagram showing the flow of the machine learning processing according to this embodiment.

FIG. 5 is a flowchart showing the flow of the advance machine learning processing.

FIG. 6 is a flowchart showing the processing routine of the learning effect evaluation processing.

FIG. 7 is a characteristic curve diagram for explaining another embodiment.

### DESCRIPTION OF EMBODIMENTS

An embodiment of the present invention is now explained in detail with reference to the appended drawings. Note that, in the ensuing explanation, a moving image based on video data output from a camera is referred to as a “video”, and each individual still image configuring the “video” is referred to as an “image”.

(1) Configuration of Machine Learning System According to this Embodiment

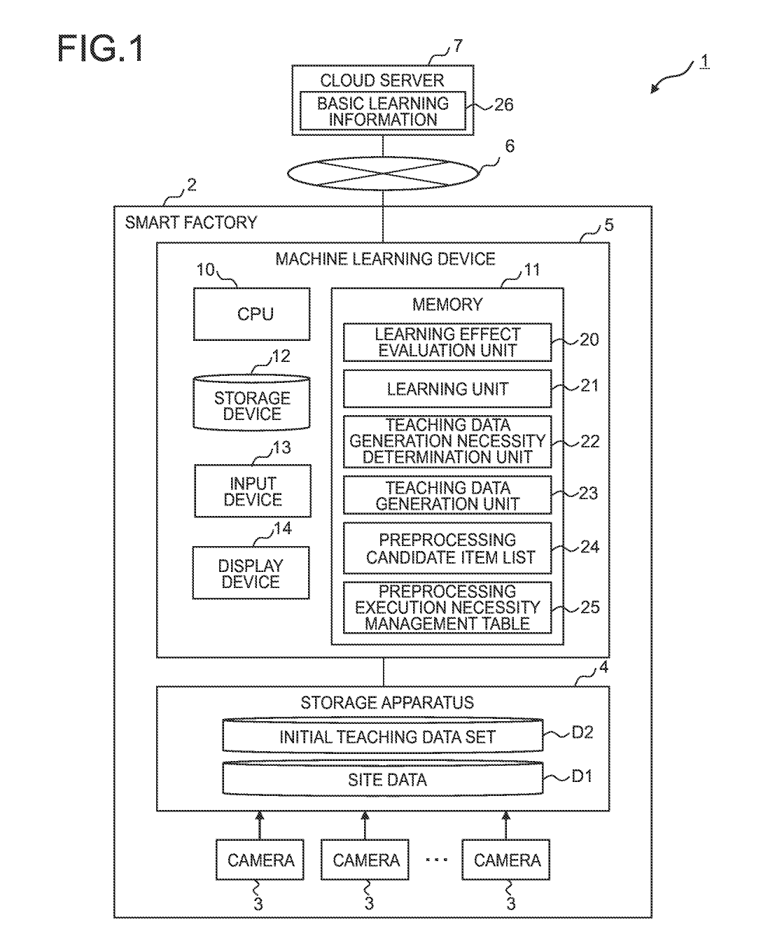

In FIG. 1, reference numeral 1 represents the machine learning system according to this embodiment. The machine learning system 1 is configured by comprising a plurality of cameras 3 disposed within the smart factory 2, a storage apparatus 4, and a machine learning device 5, and the machine learning device 5 is connected to a cloud server 7 via a network 6 such as the internet.

The camera 3 is a general-purpose imaging device each disposed at a predetermined location within the smart factory 2, and sends video data, which was obtained via imaging, to the storage apparatus 4. Moreover, the storage apparatus 4 is configured from a large-capacity storage device such as RAID (Redundant Arrays of Inexpensive Disks), and stores the video data sent from the camera 3 as site data D1.

The machine learning device 5 is configured from a general-purpose computer device comprising a CPU (Central Processing Unit) 10, a memory 11, a storage device 12, an input device 13 and a display device 14.

The CPU 10 is a processor which governs the operational control of the overall machine learning device 5. Moreover, the memory 11 is configured, for example, from a volatile semiconductor memory, and is used for temporarily storing and retaining various programs and necessary data. The learning effect evaluation unit 20, the learning unit 21, the teaching data generation necessity determination unit 22, the teaching data generation unit 23, the preprocessing candidate item list 24 and the preprocessing execution necessity management table 25 described later are also stored and retained in the memory 11.

The storage device 12 is configured from a nonvolatile storage device such as a hard disk device or a SSD (Solid State Drive), and is used for retaining programs and data for a long period. As a result of the programs stored in the storage device 12 being loaded into the memory upon the activation of the machine learning device 5 or when required, and the programs loaded into the memory 11 being executed by the CPU 10, various types of processing as the overall machine learning device 5 described later are thereby performed.

The input device 13 is configured from a keyboard or a mouse, and is used by an operator for inputting necessary instructions and information. Moreover, the display device 14 is configured from a liquid crystal display or an organic EL (Electro Luminescence) display, and is used for displaying necessary information and GUI (Graphical User Interface).

The cloud server 7 is configured from a general-purpose server device comprising information processing resources such as a CPU and a memory, and retains a model (this is hereinafter referred to as the “basic learning information”) 26 configured from the learning results of image recognition which can be commonly used in various smart factories. The basic learning information 26 is obtained based on deep learning performed in existing smart factories.

(2) Advance Machine Learning Function According to this Embodiment

The advance machine learning function equipped in the machine learning device 5 is now explained. The machine learning method in the machine learning device 5 is referred to as “transfer learning” of downloading the basic learning information 26 retained in the cloud server 7 via the network 6, and using the downloaded basic learning information 26 to learn the learning target in the smart factory 2 (to tune the basic learning information 26).

The machine learning device 5 is characterized in having an advance machine learning function which, upon tuning the basic learning information 26, generates one or more processed images by performing, to each image based on a teaching data set prepared in advance (this is hereinafter referred to as the “initial teaching data set”), image processing (this is hereinafter referred to as “preprocessing”) having a high learning effect regarding the learning target included in that image, and performs additional learning of the learning target with the image data of the generated processed images as the teaching data.

In effect, with the machine learning system 1, the operator initially sets, in the machine learning device 5, one or more types of preprocessing (this is hereinafter referred to as the “effective preprocessing”) capable of obtaining a higher learning effect when learning the learning target by using, as the teaching data, the image data of the processed image obtained by performing preprocessing, among a plurality of types of preprocessing prescribed in advance, to the image including the learning target for each of the learning targets.

Note that, as the types of preprocessing described above, considered may be image processing of changing the brightness, saturation or lightness of the learning target and/or the background in the image, or image processing of inverting the left/right or the top/bottom of the learning target and/or the background in the image.

Moreover, as the method of setting the effective preprocessing for each learning target in the machine learning device 5, applied may be a method of the machine learning device 5 downloading from the cloud server 7 and internally setting information related to the effective preprocessing for each learning target decided based on the learning effect evaluation processing described later, which was executed in advance at a different location, or a method of the machine learning device 5 executing the learning effect evaluation processing in the smart factory 2 and thereby deciding and internally setting the effective preprocessing for each learning target.

Moreover, the operator initially operates the machine learning device 5 and downloads the basic learning information 26 from the cloud server 7 to the machine learning device 5 on the one hand, and additionally prepares in advance, in the storage apparatus 4, an image data set of a minimum number of images, which include at least one learning target and in which that learning target has been labeled, as the initial teaching data set D2.

The operator thereafter causes the machine learning device 5 to perform tuning processing (this is hereinafter referred to as the “advance machine learning processing”) of using the initial teaching data set D2 and tuning the basic learning information 26.

When the machine learning device 5 starts the advance machine learning processing, the machine learning device 5 foremost uses the initial teaching data set D2 and executes a first round of active learning of each learning target. Here, because the learning target in each image based on the initial teaching data set D2 has already been labeled, the operator is not required to perform the labeling operation to the learning target in each image during the first round of active learning.

When the machine learning device 5 completes the first round of active learning, the machine learning device 5 starts the second round of active learning, and, by performing each preprocessing, which was set as the effective preprocessing regarding the learning target existing in that image, to each image based on the initial teaching data set D2, generates processed images which were respectively subject to the foregoing preprocessing.

For example, when a certain learning target exists in an image and image processing of respectively changing the brightness, saturation and lightness of the learning target in the image has been set as the effective preprocessing regarding that learning target, a processed image in which the brightness of the learning target in that image has been changed, a processed image in which the saturation of the learning target in that image has been changed, and a processed image in which the lightness of the learning target in that image has been changed, are respectively generated.

Subsequently, the machine learning device 5 learns the learning target by executing the second round of active learning with the image data of each of the thus generated processed images as the new teaching data (this is hereinafter referred to as the “artificial teaching data”).

Note that, because the learning target in each image based on the initial teaching data set has already been labeled, the learning target in each image based on the artificial teaching data has also already been labeled. Thus, even in the second round of active learning, the operator is not required to perform the labeling operation to the learning target in the image based on the artificial teaching data.

When the machine learning device 5 completes the second round of active learning, the machine learning device 5 ends the tuning processing (advance machine learning processing) of the basic learning information 26, and thereafter starts the normal operation.

As means for realizing the advance machine learning function according to this embodiment described above, the memory 11 of the machine learning device 5 stores, as shown in FIG. 1, a learning effect evaluation unit 20, a learning unit 21, a teaching data generation necessity determination unit 22 and a teaching data generation unit 23 as programs, and additionally stores a preprocessing candidate item list 24 and a preprocessing execution necessity management table 25 as control information.

The learning effect evaluation unit 20 is a function of evaluating the learning effect for each preprocessing while referring to the preprocessing candidate item list 24 described later, which is a list of a plurality of preprocessing prescribed in advance, for each learning target. The learning effect evaluation unit 20 determines the preprocessing (effective preprocessing) to be performed to the image including the learning target, for each learning target, based on the evaluation result, and sets the determination result in the preprocessing execution necessity management table 25 described later.

The learning unit 21 is a program which executes deep learning by using a neutral network such as CNN (Convolution Neural Network) or RNN (Recurrent Neural Network). The learning unit 21 learns each learning target based on the foregoing initial teaching data set D2 and artificial teaching data upon tuning the basic learning information 26 (upon performing the advance machine learning processing).

Moreover, during normal operation, the learning unit 21 executes recognition processing of recognizing the learning target included in each image based on the site data D1 accumulated in the storage apparatus 5 based on the previous learning results, and additionally requests the operator to label images with a low accuracy of the learning target. When the labeling of the learning target is performed to the corresponding image, the learning unit 21 learns the learning target with the image data of that image data as the teaching data.

The teaching data generation necessity determination unit 22 is a program with a function of referring to the preprocessing execution necessity management table 25 and determining whether some type of preprocessing should be performed to an image (whether a processed image of an image should be generated) regarding each image based on the initial teaching data set D2 upon executing the second round of active learning of the advance machine learning processing described above. When the teaching data generation necessity determination unit 22 obtains a positive result in the foregoing determination, the teaching data generation necessity determination unit 22 instructs the teaching data generation unit 23 to generate a processed image of that image.

Moreover, with regard to an image which was labeled as a learning target by the operator during normal operation, the teaching data generation necessity determination unit 22 also refers to the preprocessing execution necessity management table 25 and determines whether some type of preprocessing should be performed to that image. When the teaching data generation necessity determination unit 22 obtains a positive result in the foregoing determination, the teaching data generation necessity determination unit 22 instructs the teaching data generation unit 23 to generate a processed image of that image.

The teaching data generation unit 23 is a program with a function of generating a processed image of the image for which the generation of a processed image thereof was instructed by the teaching data generation necessity determination unit 22.

In effect, when the teaching data generation unit 23 is instructed by the teaching data generation necessity determination unit 22 to generate a processed image of a certain image upon the execution of the second round of active learning of the advance machine learning processing described above, or during normal operation that is started after the advance machine learning processing, the teaching data generation unit 23 searches the preprocessing execution necessity management table 25 for the effective preprocessing that has been set regarding the learning target in that image, and generates one or more processed images of that image by individually performing each effective preprocessing, which was detected based on the foregoing search, to that image. The teaching data generation unit 23 subsequently sends, to the learning unit 21, the image data of each of the thus generated processed image as the foregoing artificial teaching data.

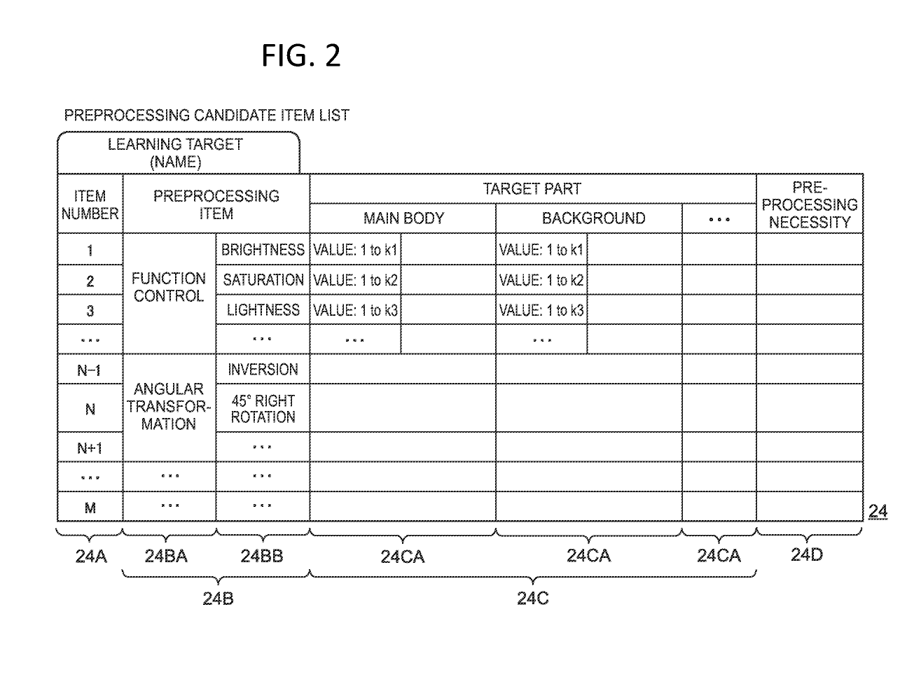

Meanwhile, the preprocessing candidate item list 24 is a list which is used when the learning effect evaluation unit 20 evaluates the learning effect for each preprocessing to be performed to each learning target, and is created for each learning target. The preprocessing candidate item list 24 is configured by comprising, as shown in FIG. 2, an item number column 24A, a preprocessing item column 4B, a target part column 24C and a preprocessing necessity column 24D. In the preprocessing item candidate list 24, one line corresponds to one preprocessing item.

The item number column 24A stores the item number which is assigned to the corresponding preprocessing. Moreover, the preprocessing item column 4B is configured from a preprocessing major item column 4BA and a preprocessing minor item column 4BB. The preprocessing major item column 4BA stores the name of the major items in cases where the preprocessing is divided into several major items according to the contents thereof, and the preprocessing minor item column 4BB stores the name of the minor item of the preprocessing belonging to the corresponding major item.

Note that, as the major items of the preprocessing, considered may be “function control” which enables the adjustment of parameter values of the parameters of preprocessing to be performed to the part to be processed (this is hereinafter referred to as the “target part”) such as the learning target and the background in the image, and “angular transformation” for changing the direction of the target part in the image. Moreover, as the minor items of the contents of the preprocessing, for example, when the major item is “function control”, considered may be “brightness” which changes the parameter value of the brightness of the target part in the image, “saturation” which changes the parameter value of the saturation of that target part, or “lightness” which changes the parameter value of the lightness of that target part, and, when the major item is “angular transformation”, considered may be “inversion” of inverting the left/right direction of the target part in the image. The term “preprocessing” as used in this embodiment refers to the minor item of such preprocessing.

Furthermore, the target part column 24C is configured from a plurality of part columns 24CA each corresponding to the target part in the image. Here, as the “target part in the image”, considered may be “main body” which represents the learning target in the image, and “background” which represents the background of that learning target. Each part column 24CA stores the learning effect evaluated value in the case of performing preprocessing to the corresponding target part in the image including the corresponding learning target.

Note that, in this embodiment, the learning effect evaluated value as a difference between the accuracy (recognition rate) of the learning target when the learning unit 21 performed the recognition processing of recognizing that learning target in another second image including that target after the learning unit 21 learned the learning target by using, as the teaching data, the image data of the processed image obtained by performing corresponding preprocessing to the corresponding target part in a first image including the corresponding learning target, and the accuracy of the learning target when the learning unit 21 performed the recognition processing of recognizing that learning target in the original first image.

Moreover, the preprocessing image part column 24CA in which the preprocessing major item is “function control” stores, in sequential order, the respective learning effect evaluated values when incrementing each corresponding parameter (for instance, the brightness parameter when the preprocessing minor item is “brightness”, and the saturation parameter when the preprocessing item is “saturation”) one by one from 1 to the maximum value of that parameter.

Furthermore, the preprocessing necessity column 24D stores the determination result of whether it is necessary to perform the preprocessing of the corresponding item to the corresponding learning target which was determined by the learning effect evaluation unit 20 (FIG. 1) based on the learning effect evaluated value stored in each corresponding part column 24CA.

Specifically, when all learning effect evaluated values stored in each image part column 23CA of the same line are less than the learning effect evaluation reference value which was set for that learning effect evaluated value, “Not necessary” is stored as the foregoing determination result in the preprocessing necessity column 24D, and when at least one of those learning effect evaluated values is equal to or greater than the learning effect evaluation reference value, “Necessary” is stored as the foregoing determination result in the preprocessing necessity column 24D.

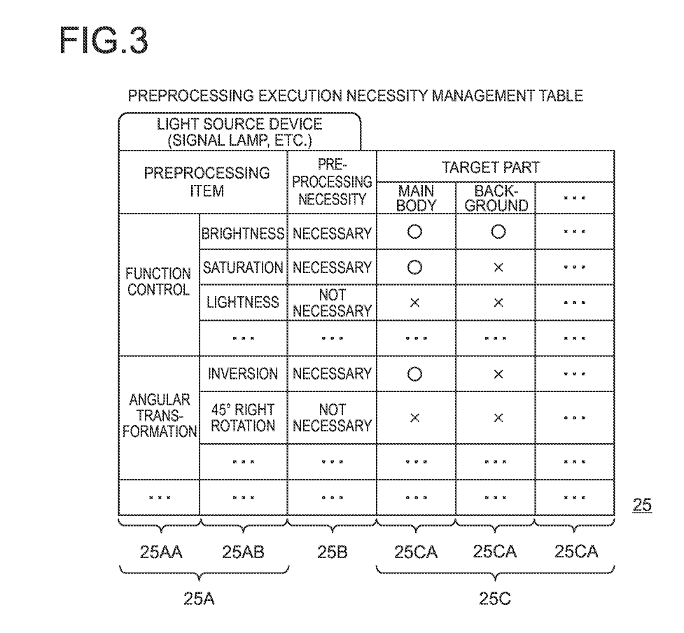

Meanwhile, the preprocessing execution necessity management table 25 is a table which is created for each learning target, and used for managing the preprocessing to be performed to the image including the corresponding learning target which was set for that learning target. The preprocessing execution necessity management table 25 is configured by comprising, as shown in FIG. 3, a preprocessing item column 25A, a preprocessing necessity column 25B and a target part column 25C. In the preprocessing execution necessity management table 25, one line corresponds to one preprocessing item.

The preprocessing item column 25A is configured from a preprocessing major item column 5AA and a preprocessing minor item column 5AB. The preprocessing major item column 5AA and the preprocessing minor item column 5AB respectively store the same information as the information stored in the corresponding preprocessing major item column 4BA or preprocessing minor item column 4BB of the preprocessing candidate item list 24.

Moreover, the preprocessing necessity column 25B stores information representing whether corresponding preprocessing should be performed to the image including the corresponding learning target. Specifically, “Necessary” is stored in the preprocessing necessity column 25B when corresponding preprocessing should be performed, and “Not necessary” is stored in the preprocessing necessity column 25B when it is not necessary to perform corresponding preprocessing. Accordingly, preprocessing for which “Necessary” is stored in the preprocessing necessity column 25B corresponds to the foregoing effective preprocessing.

Furthermore, the target part column 25C is configured from a plurality of part columns 25CA each corresponding to each part (target part) in the image which may be subject to processing in the same manner as the target part column 24C of the preprocessing candidate item list 24.

The part column 25CA stores information representing whether corresponding preprocessing should be performed to the corresponding target part in each target image. For instance, in the example shown in FIG. 3, “o” is stored when such preprocessing should be performed, and “x” is stored when such preprocessing should not be performed.

Accordingly, the example of FIG. 3 shows that, when the learning target is a “light source device” of a signal lamp, it is necessary to create a processed image which was subject to preprocessing of changing at least the parameter value of the brightness of the main body (learning target) and its background (preprocessing necessity of the line in which the minor item is “brightness” is “Necessary”, and the main body and the background are “o”), and a processed image which was subject to preprocessing of changing at least the parameter value of the saturation of the main body (processing necessity of the line in which the minor item is “saturation” is “Necessary”, and the main body is “o” and the background is “x”).

Moreover, in addition to the above, FIG. 3 also shows that it is necessary to create a processed image which was subject to preprocessing of inverting the left/right direction of the main body (learning target) (preprocessing necessity of the line in which the minor item is “inversion” is “Necessary”, and the main body is “o” and the background is “x”).

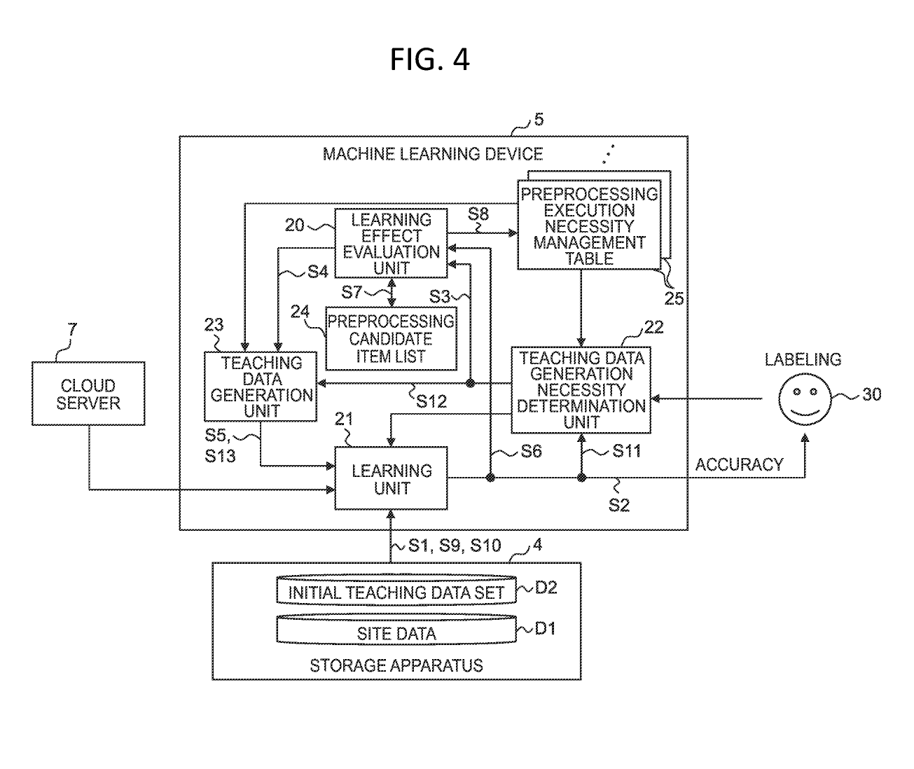

FIG. 4 shows the flow of the series of processing that is executed by the learning effect evaluation unit 20, the learning unit 21, the teaching data generation necessity determination unit 22 and the teaching data generation unit 23 in relation to the machine learning function of this embodiment described above.

The flow of processing to be performed when the preprocessing execution necessity management table 25 is not prepared in the machine learning device 5 in advance is foremost explained. In the foregoing case, the learning effect evaluation unit 20 determines, for each learning target, the preprocessing (effective preprocessing) to be performed to the image including that learning target, and sets the determination result in the preprocessing execution necessity management table 25.

In effect, the learning effect evaluation unit 20 in the foregoing case foremost instructs the learning unit 21 to start active learning for creating the preprocessing execution necessity management table 25.

When the learning unit 21 receives the foregoing instruction, the learning unit 21 acquires, among the site data D1 retained in the storage apparatus 4, the site data D1 of one learning target among the site data D1 for each learning target designated by the operator in advance for use in creating the preprocessing execution necessity management table 25 (S1), and executes, for each image based on the acquired site data D1, recognition processing of recognizing the learning target in that image. Moreover, with regard to an image with a low accuracy of the learning target, the learning unit 21 displays that image and necessary information on the display device 14 (FIG. 1), and thereby requests the operator 30 to label that labeling target in that image (S2).

Subsequently, when the operator 30 labels that learning target in that image, the learning unit 21 transfers the image data of that image (including information of the label assigned by the operator 30) and the accuracy of the learning unit 21 to that learning target to the learning effect evaluation unit 20 via the teaching data generation necessity determination unit 22 (S3).

When the learning effect evaluation unit 20 receives the image data of that image and the like, the learning effect evaluation unit 20 selects one preprocessing among the preprocessing listed in the preprocessing candidate item list 24 and one part (target part) in the image to be subject to that preprocessing, instructs the teaching data generation unit 23 to perform such preprocessing to that part in that image, and transfers the image data of that image to the teaching data generation unit 23 (S4).

Consequently, in accordance with the foregoing instruction, the teaching data generation unit 23 performs the designated preprocessing to the part (target part) designated regarding the image data transferred from the learning effect evaluation unit 20, and sends the consequently obtained image data of the processed image, as the teaching data, to the learning unit 21 (S5).

The learning unit 21 learns the corresponding learning target based on the teaching data transferred from the teaching data generation unit 23. Moreover, the learning unit 21 reads the same site data D1, before performing that preprocessing, from the storage apparatus 4 once again, once again performs the recognition processing of recognizing that learning target included in each image based on that site data D1, and notifies the accuracy of that learning target to the learning effect evaluation unit 20 (S6).

When the foregoing accuracy is notified from the learning unit 21, the learning effect evaluation unit 20 compares the accuracy of the learning target obtained based on the recognition processing performed by the learning unit 21 before the teaching data generation unit 23 generates the teaching data regarding that image, and the accuracy of the learning target obtained based on the recognition processing performed by the learning unit 21 after learning the learning target based on the teaching data regarding that image, and stores the difference of the foregoing accuracies as the learning effect evaluated value in the corresponding part column 24CA (FIG. 3) of the preprocessing candidate item list 24 (S7).

Subsequently, the learning effect evaluation unit 20, the teaching data generation unit 23 and the learning unit 21 respectively perform the foregoing processing for each target part listed in the preprocessing candidate item list 24 regarding the same image. Here, with regard to the preprocessing in which the major item is “function control” (preprocessing in which the minor item names are, for instance, “brightness”, “saturation” and “lightness”), the learning effect evaluation unit 20 instructs the learning unit 21 and the teaching data generation unit 23 to perform the foregoing processing to each target part while changing the parameter value of the corresponding parameter one by one.

When the learning effect evaluation unit 20 completes storing the learning effect evaluated value for each target part regarding one preprocessing in the corresponding part column 24CA of the preprocessing candidate item list 24 in the manner described above, the learning effect evaluation unit 20 determines, based on the learning effect evaluated value for each target part, whether it would be effective to use, as the teaching data, the image data of the processed image obtained by performing such preprocessing to the image including that learning target, and stores the determination result in the preprocessing necessity column 24D (FIG. 2) of the preprocessing candidate item list 24 (S7).

Specifically, when the learning effect evaluated value of at least one target part among the respective target parts is equal to or greater than the foregoing learning effect evaluation reference value, which was set in advance regarding that target part, the learning effect evaluation unit 20 stores “Necessary”, which means that such preprocessing should be performed to the image including that learning target, in the corresponding preprocessing necessity column 24D (FIG. 3) of the preprocessing candidate item list 24.

Moreover, when the learning effect evaluated values of all target parts are less than the foregoing learning effect evaluation reference value, which was set in advance regarding that target part, the learning effect evaluation unit 20 stores “Not necessary”, which means that it is not necessary to perform such preprocessing to the image including that learning target, in the corresponding preprocessing necessity column 24D of the preprocessing candidate item list 24.

Subsequently, the learning effect evaluation unit 20 sequentially determines the necessity of each preprocessing to the target learning target by executing the foregoing processing regarding all preprocessing, and sequentially stores the determination result in the corresponding preprocessing necessity column 24D of the preprocessing candidate item list 24 (S7).

Furthermore, the learning effect evaluation unit 20 creates the preprocessing candidate item list 24 for each learning target, in which the necessity was registered for each preprocessing to each learning target, by similarly performing the foregoing processing regarding all learning targets (S7).

The learning effect evaluation unit 20 thereafter creates the preprocessing execution necessity management table 25 for each learning target based on the preprocessing candidate item list 24 created for each learning target in the manner described above (S8).

Specifically, the learning effect evaluation unit 20 foremost selects one learning target. Subsequently, the learning effect evaluation unit 20 selects one preprocessing among the preprocessing listed in the preprocessing candidate item list 24 of the learning target that was selected (this is hereinafter referred to as the “selected learning target”), and stores the information (“Necessary” or “Not necessary”), which is stored in the preprocessing necessity column 24D (FIG. 2) of the line corresponding to the preprocessing that was selected (this is hereinafter referred to as the “selected preprocessing”), in the preprocessing necessity column 25B (FIG. 3) of the line corresponding to the selected preprocessing of the preprocessing execution necessity management table 25 corresponding to that selected learning target.

Moreover, the learning effect evaluation unit 20 stores the information (“o” or “x”), which is stored in each part column 24CA (FIG. 2) of the line corresponding to the selected preprocessing in the preprocessing candidate item list 24, in the corresponding part column 25CA (FIG. 3) of the line corresponding to the selected preprocessing of the preprocessing execution necessity management table 25 corresponding to that selected learning target.

The learning effect evaluation unit 20 sequentially performs the foregoing processing regarding all preprocessing in relation to that selected learning target. Moreover, the learning effect evaluation unit 20 thereafter performs the foregoing processing regarding all learning targets. The learning effect evaluation unit 20 thereby creates the preprocessing execution necessity management table 25 for each learning target.

When the learning effect evaluation unit 20 completes creating the preprocessing execution necessity management table 25 of each learning target in the manner described above, the learning effect evaluation unit 20 instructs the learning unit 21 to start the advance learning processing of tuning the basic learning information 26.

When the learning unit 21 receives the foregoing instruction, the learning unit 21 foremost reads the initial teaching data set D2 from the storage apparatus 4, and learns each learning target by executing the first round of active learning by using the read initial teaching data set D2 and the basic learning information 26 (S9).

Next, the learning unit 21 starts the second round of active learning and reads the initial teaching data set D2 from the storage apparatus 4 (S10), and sequentially sends, to the teaching data generation necessity determination unit 22, the image data of each image based on the read initial teaching data set D2 (S11).

The teaching data generation necessity determination unit 22 refers to the preprocessing execution necessity management table 25 corresponding to the learning target included in the image based on that image data each time that image data is provided from the learning unit 21, notifies all preprocessing to be performed to that image (preprocessing in which “Necessary” is stored in the preprocessing necessity column) and the target part of such preprocessing (target part in which “o” is stored in the target part column) to the teaching data generation unit 23, and additionally sends the image data of that image to the teaching data generation unit 23 (S12).

Consequently, the teaching data generation unit 23 generates a processed image of each image based on the image data provided from the teaching data generation necessity determination unit 22 obtained by performing each preprocessing designated by the teaching data generation necessity determination unit 22 to each designated target part, and sends the image data of the generated processed image, as the artificial teaching data, to the learning unit 21 (S13).

When the learning unit 21 receives the foregoing artificial teaching data, the learning unit 21 learns each learning target by using the artificial teaching data. Moreover, when the learning unit 21 completes learning the learning target by using the artificial teaching data, the learning unit 21 thereafter switches the operation mode to a normal operation mode, and starts the operation in a normal operation mode.

(3) Specific Processing Contents Related to Advance Machine Learning Function

The processing contents of the various types of processing performed in the machine learning device 5 in relation to the advance machine learning function of this embodiment described above are now explained. Note that, in the ensuing explanation, while the processing subject of the various types of processing is explained as a “program” such as the learning unit 21, it goes without say that, in effect, the CPU 10 (FIG. 1) performs such processing based on that “program”.

(3-1) Advance Machine Learning Processing

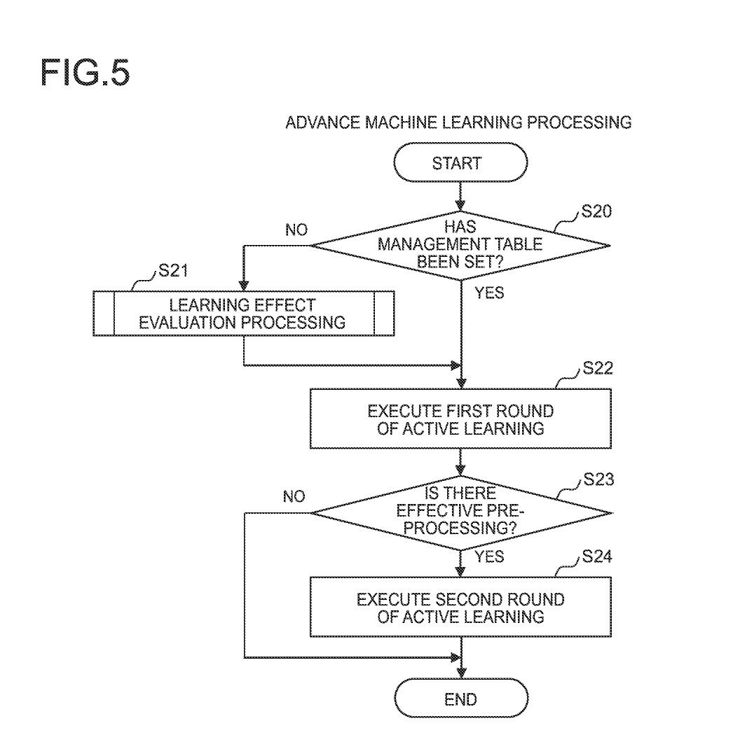

FIG. 5 shows the sequential flow of the advance machine learning processing performed in the machine learning device 5 of this embodiment. This machine learning processing is started as a result of the operator downloading the foregoing basic learning information 26 (FIG. 1) from the cloud server 7 to the machine learning device 5, setting the storage location of the foregoing initial teaching data set D2 (FIG. 1), which is to be used for tuning the basic learning information 26, in the storage apparatus 3 to be the machine learning device 5, and thereafter instructing the machine learning device 5 to perform the advance machine learning processing via the input device 13 (FIG. 1).

When the machine learning device 5 receives the foregoing instruction, the machine learning device 5 foremost determines whether the learning effect evaluation unit 20 has stored necessary information in the preprocessing execution necessity management table 25 for each learning target (S20). When the learning effect evaluation unit 20 obtains a negative result in the foregoing determination, the learning effect evaluation unit 20 performs the learning effect evaluation processing of evaluating each learning effect for each preprocessing of each learning target and creating the preprocessing execution necessity management table 25 (S21).

Next, the learning effect evaluation unit 20 controls the learning unit 21, the teaching data generation necessity determination unit 22 and the teaching data generation unit 23 and causes them to execute the first round of active learning for tuning the basic learning information 26 (S22). Based on this active learning, each learning target is learned by using the initial teaching data set D2 and the basic learning information 26.

When the first round of active learning is completed, the learning effect evaluation unit 20 thereafter determines whether “Necessary” is stored in at least one preprocessing necessity column of at least one preprocessing execution necessity management table 25 (S23).

To obtain a negative result in the foregoing determination means that there is no effective preprocessing regarding all learning targets (that is, there is no preprocessing having a high learning effect regarding any learning target). Consequently, in the foregoing case, the learning effect evaluation unit 20 ends the advance machine learning processing, and thereafter instructs the learning unit 21 and the like to start normal operation.

Meanwhile, to obtain a positive result in the determination of step S23 means that there is effective preprocessing regarding at least one learning target (that is, there is preprocessing having a high learning effect regarding any learning target). Consequently, in the foregoing case, the learning effect evaluation unit 20 controls the learning unit 21 and the teaching data generation necessity determination unit 22 and causes them to execute the second round of active learning of the advance machine learning processing (S24).

When the learning effect evaluation unit 20 completes the second round of active learning, the learning effect evaluation unit 20 ends the tuning processing of the basic learning information 26 (advance machine learning processing), and thereafter instructs the learning unit 21 and the like to start normal operation.

(3-2) Learning Effect Evaluation Processing

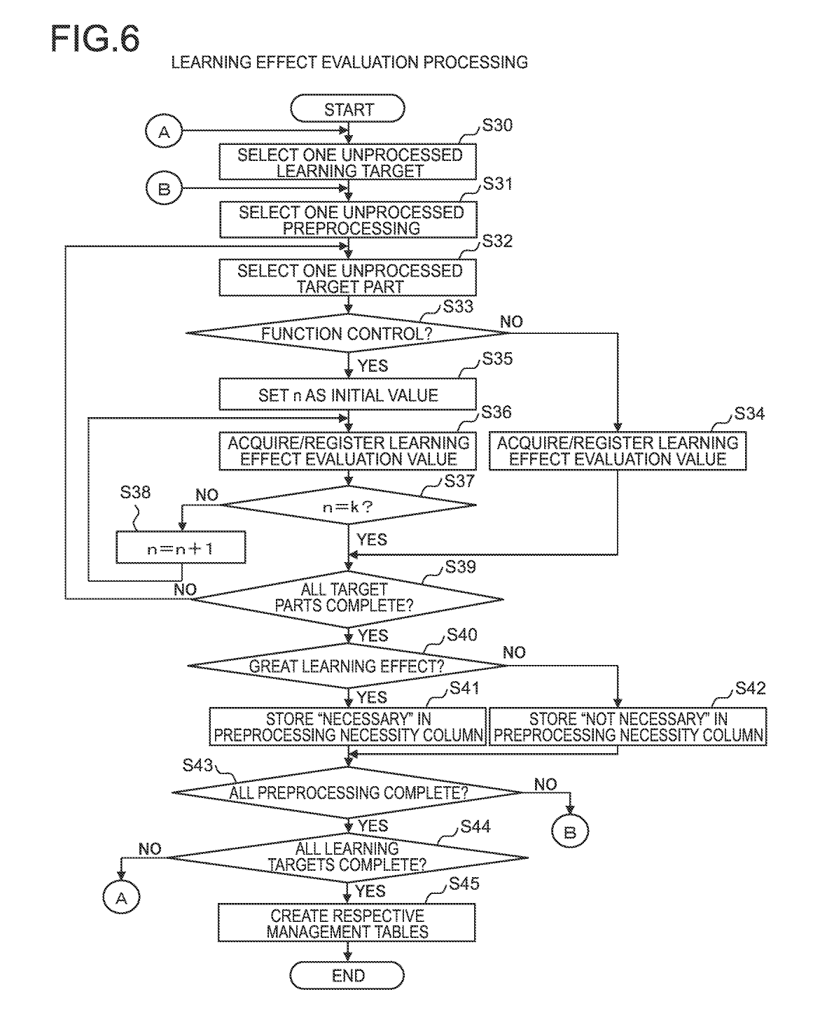

Meanwhile, FIG. 6 shows the processing routine of the learning effect evaluation processing to be performed by the learning effect evaluation unit 20 in step S21 of the advance machine learning processing described above with reference to FIG. 5.

When the learning effect evaluation unit 20 proceeds to step S21 of the advance machine learning processing, the learning effect evaluation unit 20 starts the learning effect evaluation processing shown in FIG. 6, and foremost selects one learning target among the learning targets which has not yet been subject to the processing of step S31 onward (S30).

Next, the learning effect evaluation unit 20 refers to the preprocessing candidate item list 24 (FIG. 2), and selects one preprocessing among the preprocessing registered in the preprocessing candidate item list 24 which has not yet been subject to the processing of step S32 onward (S31).

Furthermore, the learning effect evaluation unit 20 selects one target part which has not yet been subject to the processing of step S33 onward regarding the preprocessing selected in step S30 (this is hereinafter referred to as the “selected preprocessing”) (S32), and thereafter determines whether the major item of the selected preprocessing is “function control” (S33).

When the learning effect evaluation unit 20 obtains a negative result in the foregoing determination, the learning effect evaluation unit 20 acquires, based on the routine described above with reference to FIG. 4, the learning effect evaluated value in the case of performing the selected preprocessing to the target part selected in step S32 (this is hereinafter referred to as the “selected target part”) regarding the image including the learning target selected in step S20 (this is hereinafter referred to as the “selected learning target”), and registers the acquired learning effect evaluated value in the corresponding part column 24CA of the preprocessing candidate item list 24 (FIG. 2) corresponding to that selected learning target (S34). The learning effect evaluation unit 20 thereafter proceeds to step S39.

Meanwhile, when the learning effect evaluation unit 20 obtains a positive result in the determination of step S33, the learning effect evaluation unit 20 sets the parameter value n of the parameter corresponding to the selected preprocessing (“brightness”, “saturation” or “lightness”) to the initial value (for instance, “0”) (S35).

The learning effect evaluation unit 20 thereafter acquires, based on the routine described above with reference to FIG. 4, the learning effect evaluated value in the case of performing the selected preprocessing to the selected target part upon setting the parameter value of the corresponding parameter to “n” regarding the image including the selected learning target. Moreover, the learning effect evaluation unit 20 registers the thus acquired learning effect evaluated value in the corresponding part column 24CA of the preprocessing candidate item list 24 (FIG. 2) corresponding to that selected learning target (S36).

Subsequently, the learning effect evaluation unit 20 determines whether the parameter value of the corresponding parameter has reached the maximum value k of that parameter (S37). For example, when the settable range of the parameter value of the parameter of “brightness” is 0 to 100, the maximum value k of that parameter will be “100”.

When the learning effect evaluation unit 20 obtains a negative result in the foregoing determination, the learning effect evaluation unit 20 increments the value of the parameter value n by 1 (S38), and thereafter returns to step S36. The learning effect evaluation unit 20 subsequently repeats the processing of step S36 to step S38 until a positive result is obtained in step S37.

Based on this repetitive processing, upon performing the selected preprocessing to the selected target part regarding the image including the selected learning target, it is possible to sequentially acquire the learning effect evaluated value with each parameter value in the case of sequentially changing the parameter value of the corresponding parameter from 1 to maximum value k. The acquired learning effect evaluated values are then sequentially registered in the corresponding part column 24CA of the corresponding preprocessing candidate item list 24.

When the learning effect evaluation unit 20 obtains a positive result in step S37 as a result of completing the acquisition of the learning effect evaluated value with each parameter value in the case of sequentially changing the parameter value of the parameter related to the selected preprocessing from 1 to maximum value k, the learning effect evaluation unit 20 determines whether the processing of step S33 to step S38 has been performed for all target parts registered in the preprocessing candidate item list 24 (S39).

When the learning effect evaluation unit 20 obtains a negative result in step S39, the learning effect evaluation unit 20 returns to step S32, and thereafter repeats the processing of step S32 to step S39 while sequentially switching the target part to be selected in step S32 to another unprocessed target part.

When the learning effect evaluation unit 20 eventually obtains a positive result in step S39 as a result of performing the processing of step S32 to step S38 for all target parts registered in the preprocessing candidate item list 24, the learning effect evaluation unit 20 determines whether the learning effect is great regarding the selected preprocessing when using, as the teaching data, the image data of the image obtained by performing the selected preprocessing to the image including the selected learning target (S40).

Specifically, with regard to any preprocessing other than those in which the major item is “control function”, the learning effect evaluation unit 20 compares, for each target part, the learning effect evaluated value of that target part with the learning effect evaluation reference value, and, when the learning effect evaluated value of any target part is equal to or greater than the learning effect evaluation reference value, the learning effect evaluation unit 20 determines that the learning effect, in the case of using, as the teaching data, the image data of the image obtained by performing the selected preprocessing to the image including the selected learning target, is great. Meanwhile, when the learning effect evaluated value of all target parts is less than the learning effect evaluation reference value, the learning effect evaluation unit 20 determines that the learning effect, in the case of using, as the teaching data, the image data of the image obtained by performing the selected preprocessing to the image including the selected learning target, is small.

Moreover, with regard to any preprocessing in which the major item is “control function”, the learning effect evaluation unit 20 calculates as the learning effect evaluated value of the target processing, for each target part, the average value of each learning effect evaluated value which is obtained by changing the parameter value n of the corresponding parameter from 1 to maximum value k, and compares the calculated learning effect evaluated value with the foregoing learning effect evaluation reference value. When the learning effect evaluated value of any target part is equal to or greater than the learning effect evaluation reference value, the learning effect evaluation unit 20 determines that the learning effect, in the case of using, as the teaching data, the image data of the image obtained by performing the selected preprocessing to the image including the selected learning target, is great. Meanwhile, when the learning effect evaluated value of all target parts is less than the learning effect evaluation reference value, the learning effect evaluation unit 20 determines that the learning effect, in the case of using, as the teaching data, the image data of the image obtained by performing the selected preprocessing to the image including the selected learning target, is small.

When the learning effect evaluation unit 20 obtains a positive result in the determination of step S40, the learning effect evaluation unit 20 stores “Necessary”, which means that the selected preprocessing needs to be performed to the selected learning target, in the preprocessing necessity column 24D (FIG. 2) of the line of the selected preprocessing in the preprocessing candidate item list 24 (S41).

Meanwhile, when the learning effect evaluation unit 20 obtains a negative result in the determination of step S40, the stores “Not necessary”, which means that the selected preprocessing does not need to be performed to the selected learning target, in the preprocessing necessity column 24D of the line of the target preprocessing in the preprocessing candidate item list 24 (S42).

The learning effect evaluation unit 20 thereafter determines whether the processing of step S32 to step S42 has been performed regarding the selected learning target with all preprocessing listed in the preprocessing candidate item list 24 as the selected preprocessing (S43).

When the learning effect evaluation unit 20 obtains a negative result in the foregoing determination, the learning effect evaluation unit 20 returns to step S31, and thereafter repeats the processing of step S31 to step S43 while sequentially switching the preprocessing to be selected in step S31 to another unprocessed preprocessing.

When the learning effect evaluation unit 20 eventually obtains a positive result in step S43 as a result of performing the processing of step S32 to step S42 regarding the selected learning target with all preprocessing listed in the preprocessing candidate item list 24 as the selected preprocessing, the learning effect evaluation unit 20 determines whether the processing of step S31 to step S43 has been performed for all learning targets (S44).

When the learning effect evaluation unit 20 obtains a negative result in the foregoing determination, the learning effect evaluation unit 20 returns to step S30, and thereafter repeats the processing of step S30 to step S44 while sequentially switching the learning target to be selected in step S30 to another unprocessed learning target.

When the learning effect evaluation unit 20 eventually obtains a positive result in step S43 as a result of performing the processing of step S31 to step S43 for all learning targets, the learning effect evaluation unit 20 creates the preprocessing execution necessity management table 25 for each learning target in the manner described above based on the preprocessing candidate item list 24 for each learning target that was created as described above (S45), and thereafter ends the learning effect evaluation processing.

(4) Effect of this Embodiment

As described above, the machine learning device 5 of this embodiment downloads the basic learning information 26 from the cloud server 7, and learns the learning target by tuning the downloaded basic learning information 26. Here, the machine learning device 5 generates a processed image of the corresponding image by performing, for each learning target, preprocessing having a high learning effect regarding that image including that learning target, and further learns the learning target with the image data of each generated processed image as the teaching data.

Thus, according to the machine learning device 5, it is possible to create processed images having a high learning effect from a minimum number of teaching data sets, and the learning target can be learned with the image data of the created processed images as the teaching data. Consequently, according to the machine learning device 5, in addition to being able to shorten the learning time by using the basic learning information 26, because there is no need to mobilize workers or spend time for creating teaching data other than the teaching data sets, learning can be performed in a short time which is dramatically shorter in comparison to conventional technologies and, consequently, it is possible to realize a machine learning device and a machine learning method capable of performing machine learning in a short time and an efficient manner.

(5) Other Embodiments

Note that, while the foregoing embodiment explained a case of applying the present invention to the machine learning device 5 which learns the learning target in the smart factory 2, the present invention is not limited thereto, and the present invention may also be broadly applied to a machine learning device to be used in locations other than the smart factory 2.

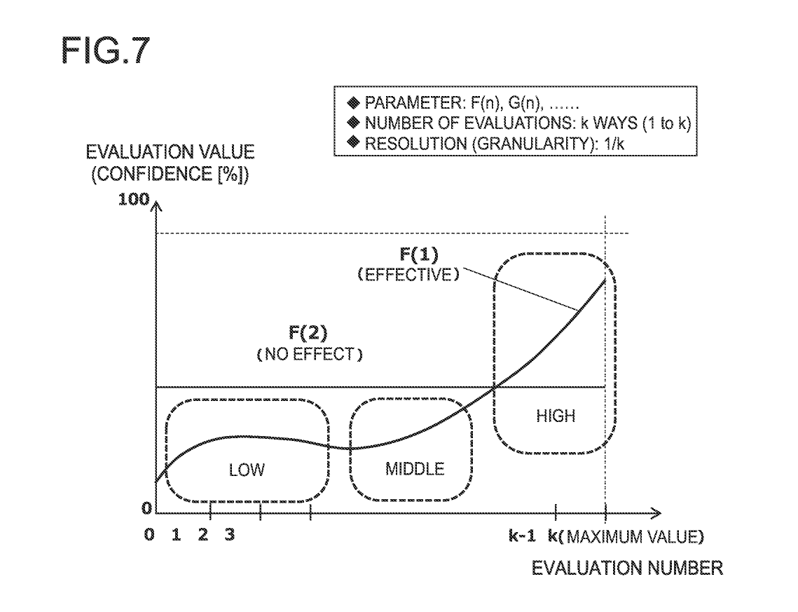

Moreover, while the foregoing embodiment explained a case of evaluating the learning effect of preprocessing in step S30 of the learning effect evaluation processing described above with reference to FIG. 6, by using, as the learning effect evaluated value, the average value of each learning effect evaluated value obtained by sequentially switching the parameter value of the corresponding parameter from 1 to maximum value k with regard to preprocessing in which the major item is “control function”, the present invention is not limited thereto, and, for instance, as shown in FIG. 7, the learning effect of the preprocessing may also be evaluated by dividing a range, in which the parameter value is 1 to maximum value k, into a plurality of ranges (for instance, into “low”, “middle” and “high” as shown in FIG. 7″), calculating the average value of each range as the learning effect evaluated value, and evaluating the learning effect of such preprocessing based on the calculated learning effect evaluated value.

For example, in the example shown in FIG. 7, because a learning effect is acknowledged when the parameter value is “high”, it is possible to determine that such preprocessing is effective preprocessing based on the premise that such preprocessing is performed based on a parameter value within that range (for instance, median value of that range). Note that, in the foregoing case, the configuration may also be such that necessary information may be set in the preprocessing execution necessity management table 25 so that the corresponding preprocessing is executed based on the foregoing parameter value, and the teaching data generation unit 23 may be configured to perform the preprocessing based on such parameter value.

Furthermore, while the foregoing embodiment explained a case of continuing to use the preprocessing execution necessity management table 25 for each learning target that was once set, the present invention is not limited thereto, and, for example, the learning effect evaluation unit 20 may suitably update the preprocessing execution necessity management table 25 by periodically or randomly performing the learning effect evaluation processing described above with reference to FIG. 6.

### INDUSTRIAL APPLICABILITY

The present invention can be applied to a machine learning device which learns a learning target based on active learning.

### REFERENCE SIGNS LIST

1 . . . machine learning system, 2 . . . smart factory, 3 . . . camera, 4 . . . storage apparatus, 5 . . . machine learning device, 7 . . . cloud server, 10 . . . CPU, 11 . . . memory, 14 . . . display device, 20 . . . learning effect evaluation unit, 21 . . . learning unit, 22 . . . teaching data generation necessity determination unit, 23 . . . teaching data generation unit, 24 . . . preprocessing candidate item list, 25 . . . preprocessing execution necessity management table, 30 . . . operator, D1 . . . site data, D2 . . . initial teaching data set.

1. A machine learning device which externally acquires basic learning information configured from basic learning results, and learns a learning target by tuning the acquired basic learning information, comprising:
a necessity determination unit which determines a necessity of image processing for each image based on a teaching data set prepared in advance;
an image processing unit which generates a processed image by performing the required image processing to each of the images in which the necessity determination unit determined that the image processing should be performed thereto; and
a learning unit which tunes the basic learning information by executing a first round of active learning by using the teaching data set, and a second round of active learning which uses image data of each of the processed images generated by the image processing unit as teaching data,
wherein, for each of the learning targets, the image processing having a high learning effect regarding the learning target is set in advance,
wherein, when the image processing has been set regarding the learning target included in the image based on the teach data set, the necessity determination unit determines that the image processing should be performed to that image, and
wherein the image processing unit generates the processed image of one or more of the images by performing each of the image processing, which was set regarding the learning target included in the image, to the image in which the necessity determination unit determined that the image processing should be performed thereto.

2. The machine learning device according to claim 1, further comprising:
a learning effect evaluation unit which evaluates, for each of a plurality of types of the image processing prescribed in advance, a learning effect in a case where the learning unit learns the learning target by using, as the teaching data, the image data of the processed image obtained by performing the image processing to the image including the learning target for each of the learning targets, and selects and sets the image processing to be performed to the image including the learning target based on an evaluation result.

3. The machine learning device according to claim 2,
wherein the learning effect evaluation unit evaluates, for each of a plurality of types of the image processing prescribed in advance, a learning effect in a case where the learning unit learns the learning target by using, as the teaching data, the image data of each the processed images obtained by performing the image processing individually to a plurality of parts prescribed in advance within the image including the learning target for each of the learning targets, and sets the image processing to be performed to the image including the learning target and sets the parts within the image to which the image processing should be performed based on an evaluation result, and
wherein the image processing unit generates the processed image of the image by performing each of the image processing, which was set regarding the learning target included in the image, to each of the parts within the image, in which the necessity determination unit determined that the image processing should be performed thereto, which was set regarding the image processing of the learning target.

4. The machine learning device according to claim 3,
wherein the learning effect evaluation unit evaluates, for each of a plurality of types of the image processing prescribed in advance, a learning effect in a case where the learning unit learns the learning target by using, as the teaching data, the image data of each the processed images obtained by performing the image processing individually to a plurality of parts prescribed in advance within the image including the learning target for each of the learning targets, and periodically executes processing of setting the image processing to be performed to the image including the learning target and setting the parts within the image to which the image processing should be performed based on an evaluation result.

5. A machine learning method to be executed by a machine learning device which externally acquires basic learning information configured from basic learning results, and learns a learning target by tuning the acquired basic learning information, comprising:
a first step of tuning the basic learning information by executing a first round of active learning by using a teaching data set prepared in advance;
a second step of determining a necessary of image processing to each image based on the teaching data set;
a third step of generating a processed image by performing the required image processing to each of the images which was determined that the image processing should be performed thereto; and
a fourth step of executing a second round of active learning which uses image data of each of the generated processed images as teaching data,
wherein, for each of the learning targets, the image processing having a high learning effect regarding the learning target is set in advance,
wherein, in the second step, when the image processing has been set regarding the learning target included in the image based on the teach data set, the machine learning device determines that the image processing should be performed to that image, and
wherein, in the third step, the machine learning device generates the processed image of one or more of the images by performing each of the image processing, which was set regarding the learning target included in the image, to the image which was determined that the image processing should be performed thereto.

6. The machine learning method according to claim 5, further comprising:
a learning effect evaluation step, which is executed before the second step, of evaluating, for each of a plurality of types of the image processing prescribed in advance, a learning effect in a case where the learning target is learned by using, as the teaching data, the image data of the processed image obtained by performing the image processing to the image including the learning target for each of the learning targets, and selects and sets the image processing to be performed to the image including the learning target based on an evaluation result.

7. The machine learning method according to claim 6,
wherein, in the learning effect evaluation step, for each of a plurality of types of the image processing prescribed in advance, a learning effect in a case where the learning unit learns the learning target by using, as the teaching data, the image data of each the processed images obtained by performing the image processing individually to a plurality of parts prescribed in advance within the image including the learning target for each of the learning targets is evaluated, and the image processing to be performed to the image including the learning target and the parts within the image to which the image processing should be performed based on an evaluation result are set, and
wherein, in the third step, the processed image of the image is generated by performing each of the image processing, which was set regarding the learning target included in the image, to each of the parts within the image, in which the necessity determination unit determined that the image processing should be performed thereto, which was set regarding the image processing of the learning target.

8. The machine learning method according to claim 7,
wherein, in the learning effect evaluation step, for each of a plurality of types of the image processing prescribed in advance, a learning effect in a case where the learning unit learns the learning target by using, as the teaching data, the image data of each the processed images obtained by performing the image processing individually to a plurality of parts prescribed in advance within the image including the learning target for each of the learning targets is evaluated, and processing of setting the image processing to be performed to the image including the learning target and setting the parts within the image to which the image processing should be performed based on an evaluation result is periodically executed.
